(19) United States
(12) Patent Application Publication
(10) Pub. No.: US 2009/0292519 A1
(43) Pub. Date: Nov. 26, 2009

(54) Circuit simulating apparatus and method thereof

(75) Inventor: Miki Terabe, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 12/379,369

(22) Filed: Feb. 19, 2009

(30) Foreign Application Priority Data
May 26, 2008 (JP) 2008-136633

(51) Int. Cl. G06F 17/50

(52) U.S. Cl. 703/14

(57) ABSTRACT

A circuit simulating apparatus includes a block dividing unit that divides a logic circuit into a plurality of partial circuits; a pattern generating unit that generates a simulation-purpose pattern to an input terminal of the partial circuit; and a phase-difference setting unit that sets a phase difference between input simultaneously-changing signals as phase-difference setting information for each input terminal of the analysis-target circuit. The apparatus also includes a signal-waveform generating unit that generates a simulation signal waveform reflecting the phase difference for each input terminal of the analysis-target circuit; and a simulation performing unit that receives an input of the simulation signal waveform for each input terminal of the analysis-target circuit to obtain a timing analysis result of the analysis-target circuit based on the input result.

### CROSS-REFERENCE TO RELATED APPLICATION

This application is based upon and claims the benefit of priority of the prior Japanese Patent Application No. 2008-136633, filed on May 26, 2008, the entire contents of which are incorporated herein by reference.

### FIELD

The embodiments discussed herein are directed to a circuit simulation program, circuit simulating apparatus, and circuit simulating method of simulating timing analysis of an input signal associated with a circuit in a Large Scale Integration (LSI) circuit.

### BACKGROUND

In recent years, in a custom macro for use in an ultrahigh-speed LSI with a clock frequency of several gigahertz, a timing analysis with extremely high accuracy is required.

As a technique for timing analysis, a timing analysis with simulation using industry-standard software Simulation Program with Integrated Circuit Emphasis (SPICE) has been known.

However, according to the timing analysis using SPICE, an extremely long processing time is required. For a specific mega custom macro as in the circuit structure of an ultrahigh-speed LSI, it is difficult to perform a timing analysis within a practical period of time.

To effectively get around this problem, a logic circuit configuring part of an ultrahigh-speed LSI is divided into a plurality of partial circuits in units of blocks, and these partial circuits in units of blocks are each taken as an analysis-target circuit, and a SPICE simulation is performed on each analysis-target circuit.

Then, the simulation results for the respective partial circuits are made into a library. With this, based on the simulation results for the respective partial circuits, a static timing analyzing process is performed on the entire logic circuit and by extension on the whole circuitry, thereby performing a timing analysis on the custom macro.

Therefore, according to the conventional circuit simulating method, timing analysis can be achieved in a practical time even for a mega custom macro as in the circuit structure of an ultrahigh-speed LSI.

The conventional technologies as explained above are exemplarily disclosed in Japanese Laid-open Patent Publication No. 2002-215710, Japanese Laid-open Patent Publication No. H07-167925, and Japanese Laid-open Patent Publication No. 2006-146595.

According to the conventional circuit simulation method described above, a simulation may be performed on each of the analysis object circuits. Assume under this situation that the analysis object circuits constitute three stages: first, preceding, and final, named according to the direction of a signal flow.

One and the same signal is drawn out from each of some output terminals of an analysis object circuit of the first stage. The first drawn-out signal may be directly applied to an analysis object circuit of the final stage without a phase change. The second drawn-out signal may be applied to an analysis object circuit of the preceding stage and then to the analysis object circuit of the final stage, with a phase thereof inverted. The third drawn-out signal may be directly fed to the analysis object circuit of the final stage without a phase change. When the first to third signals are supplied to the analysis object circuit of the final stage, respectively, a delay among the signals is produced to generate a phase difference.

Moreover, in ultrahigh-speed LSI circuit development, a timing analysis with high accuracy is required, and therefore the phase difference between signals input to each analysis-target circuit has to be precisely simulated.

However, according to the conventional circuit simulation method, even when simultaneously-changing signals are input to the analysis-target circuit, the phase difference that actually occurs is not taken into consideration, and a simulation is performed with signal waveforms of the simultaneously-changing signals without a phase difference. Therefore, under present circumstances, it is difficult to achieve a timing analysis with high accuracy.

### SUMMARY

According to an aspect of the invention, a computer readable storage medium contains instructions concerning a circuit simulation. The instructions, when executed by a computer, cause the computer to perform dividing a logic circuit including a plurality of circuits into a plurality of partial circuits in units of blocks; generating, for each of the partial circuits, a simulation-purpose pattern including information input to an input terminal of the partial circuit; and setting, when a partial circuit for analysis is specified as an analysis-target circuit from among the partial circuits, a phase difference between input simultaneously-changing signals as phase-difference setting information for each input terminal of the analysis-target circuit based on the simulation-purpose pattern corresponding to the analysis-target circuit, the simultaneously-changing signals each being obtained from one signal from a preceding circuit passing through or inverted in a different route.

Moreover, the instructions cause the computer to perform generating a simulation signal waveform reflecting the phase difference for each input terminal of the analysis-target circuit based on the simulation-purpose pattern of the analysis-target circuit and the phase-difference setting information of the analysis-target circuit; and receiving an input of the simulation signal waveform for each input terminal of the analysis-target circuit, the simulation signal waveform being generated by the signal-waveform generating unit, to obtain a timing analysis result of the analysis-target circuit based on the input result.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a circuit simulating apparatus according to an embodiment of the invention;

FIG. 2 is a block diagram of a controlling unit and a storage unit in a timing analyzing apparatus;

FIG. 3 is a drawing for illustrating a part of a logic circuit;

FIG. 4 is a drawing for illustrating a partial circuit obtained through block division of a part of the logic circuit;

FIG. 5 is a drawing for illustrating phase-difference instruction information for use in a first phase-difference setting process;

FIG. 6 is a drawing for briefly explaining details of phase-difference instruction information stored in a phase-difference instruction storage unit;

FIG. 7 is a drawing for briefly explaining a concept of route-configuration-purpose phase-difference instruction information for use in a second phase-difference setting process;

FIG. 8 is a drawing for briefly explaining details of route-configuration-purpose phase-difference instruction information stored in a route-configuration-purpose phase-difference instruction storage unit;

FIG. 9 is a drawing for briefly explaining details of settings to an analysis-target circuit when a second phase-difference setting process is performed;

FIG. 10 is a drawing for briefly explaining a concept of a third phase-difference setting process;

FIG. 11 is a drawing for briefly explaining a simulation-purpose signal waveform being shifted by a phase difference based on phase-difference setting information; and

FIG. 12 is a flowchart of a process operation of the controlling unit involved in a timing analyzing process of a timing analyzing apparatus.

### DESCRIPTION OF EMBODIMENTS

Embodiments of the present invention will be explained with reference to accompanying drawings.

First, an outline of an embodiment is explained. In performing a simulation for timing analysis on an ultrahigh LSI custom macro, when a partial circuit for analysis is specified as an analysis-target circuit, a phase difference between input simultaneously-changing signals obtained is taken as phase-difference setting information for each input terminal of the analysis-target circuit, the simultaneously-changing signals each being obtained from one signal passing through or inverted in a different route. Then, based on the phase-difference setting information of the analysis-target circuit, for each input terminal of the analysis-target circuit, a simulation signal waveform reflecting the phase difference is generated for input. As a result, a simulation reflecting the phase difference between signals being input to the analysis-target circuit is achieved, thereby achieving a timing analysis with high accuracy.

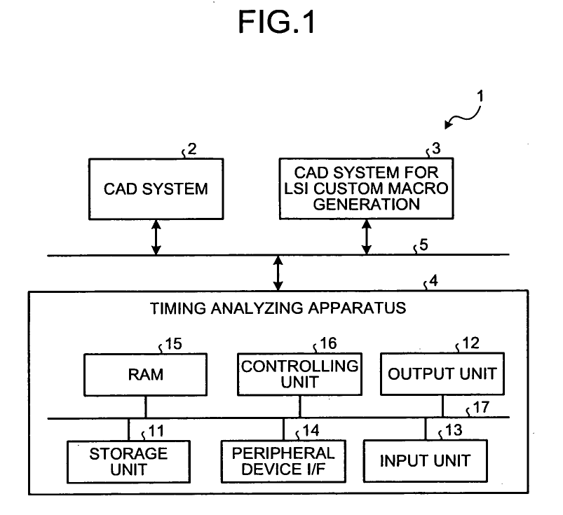

FIG. 1 is a block diagram of a circuit simulating apparatus according to the embodiment.

A circuit simulating apparatus 1 depicted in FIG. 1 includes a Computer Aided Design (CAD) system 2 that generates a SPICE net list, a CAD system for LSI custom macro generation 3 that generates an LSI custom macro, a timing analyzing apparatus 4 that performs a timing analysis on a circuit in the LSI, and a network 5 communicably connecting the CAD system 2, the CAD system for LSI custom macro generation 3, and the timing analyzing apparatus 4.

The timing analyzing apparatus 4 obtains the SPICE net list from the CAD system 2 through the network 5, performs a timing analyzing process based on the SPICE net list, generates a delay characteristic library as a result of the timing analysis, and provides the generated delay characteristic library to the CAD system for LSI custom macro generation 3 via the network 5.

The timing analyzing apparatus 4 includes a storage unit 11 that stores various information such as programs, an output unit 12 that outputs various information such as outputs information for display for example, an input unit 13 that inputs various information, and a peripheral-device interface (hereinafter, simply referred to as I/F) 14 as a communication interface for peripheral devices.

The timing analyzing apparatus 4 also includes a Random Access Memory (RAM) 15 where a program is developed, a controlling unit 16 that controls the entire timing analyzing apparatus 4 and executes the program developed on the RAM 15, and a bus 17 for transmitting data among the storage unit 11, the output unit 12, the input unit 13, the peripheral-device I/F 14, the RAM 15, and the controlling unit 16.

Here, the timing analyzing apparatus 4 may correspond to an information processing apparatus such as a personal computer, a Personal Digital Assistance (PDA), or a server.

The controlling unit 16 may correspond to a Central Processing Unit (CPU) not depicted. Also, the storage unit 11 may correspond to a non-volatile storage unit such as a hard disk, an optical disk, a magnetic disk, or a flash memory, that stores various data and programs such as an operating system program, before read into the RAM 15.

The peripheral-device I/F 14 may correspond to an interface for connecting peripheral devices to the timing analyzing apparatus 4, such as a parallel port, a Universal Serial Bus (USB) port, or a Peripheral Component Interconnect (PCI) card slot.

Also, the peripheral devices may correspond to a printer, a Small Computer System Interface (SCSI) device, a drive device, a network interface card, a keyboard, a mouse, a disk play device, and others.

The output unit 12 may correspond to a display unit that presents information to a user, such as a Cathode Ray Tube (CRT) or a liquid crystal display, as well as a voice output unit for reading instructions and information with voice, such as a loudspeaker. The input unit 13 may correspond to an input unit that inputs information of a user request with a keyboard or a mouse.

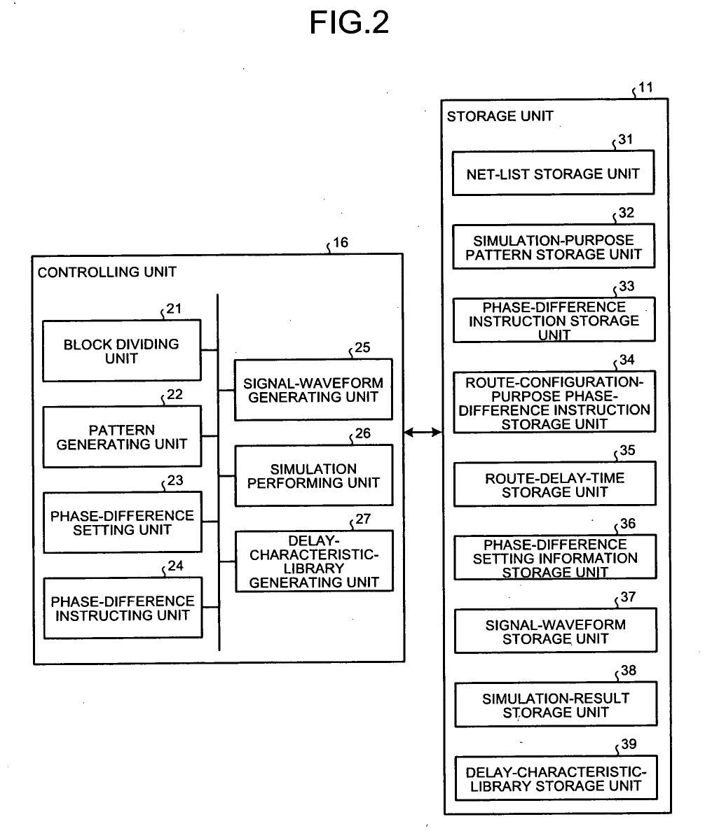

FIG. 2 is a block diagram illustrating the controlling unit 16 and the storage unit 11, which are main units of the present embodiment, in the timing analyzing apparatus 4.

The controlling unit 16 depicted in FIG. 2 includes a block dividing unit 21 that divides a logic circuit in the entire circuit into a plurality of partial circuits in units of blocks and a pattern generating unit 22 that generates, for each partial circuit, a simulation-purpose pattern including information input to an input terminal of the partial circuit.

The controlling unit 16 also includes a phase-difference setting unit 23. When a partial circuit for analysis is specified as an analysis-target circuit, the phase-difference setting unit 23 sets a phase difference between simultaneously-changing signals for each input terminal of the analysis-target circuit as phase-difference setting information, based on a simulation-purpose pattern corresponding to the analysis-target circuit. The simultaneously-changing signals each being obtained from one signal from a circuit at a preceding stage passing through or deviated in a different route.

Furthermore, the controlling unit 16 includes a phase-difference instructing unit 24 that generates phase-difference instruction information, which serves as a base for the phase-difference setting information set by the phase-difference setting unit 23.

Still further, the controlling unit 16 includes a signal-waveform generating unit 25 that generates a simulation signal waveform reflecting the phase difference for each input terminal of the analysis-target circuit based on the simulation-purpose pattern of the analysis-target circuit and the phase-difference setting information of the analysis-target circuit.

Still further, the controlling unit 16 includes a simulation performing unit 26 that receives an input of the simulation signal waveform for each input terminal of the analysis-target circuit generated by the signal-waveform generating unit 25 for each input terminal of the analysis-target circuit and, based on the input results, obtains a timing analysis result of the analysis-target circuit, that is, a delay characteristic associated with the input terminal of the analysis-target circuit.

Still further, the controlling unit 16 includes a delay-characteristic-library generating unit 27 that sequentially collects, when obtains delay characteristics associated with the input terminal of the analysis-target circuit by the simulation performing unit 26, delay characteristics associated with the input terminals of the respective analysis-target circuits and generates a delay characteristic library.

The storage unit 11 includes a net-list storage unit 31 that obtains and stores therein a SPICE net list including circuitry information of the whole circuitry managed in the CAD system 2 and a simulation-purpose pattern storage unit 32 that stores therein a simulation-purpose pattern generated by the pattern generating unit 22.

Here, the simulation-purpose pattern is equivalent to, for each partial circuit, information about inputs to the input terminal of each partial circuit, such as a signal displacement of the input signal from L to H, a signal displacement thereof from H to L, displacement timing, and combinations of input through.

The storage unit 11 also includes a phase-difference instruction storage unit 33 that stores individual pieces of phase-difference instruction information, which will be explained further below, generated by the phase-difference instructing unit 24, a route-configuration-purpose phase-difference instruction storage unit 34 that stores route-configuration-purpose phase-difference instruction information, which will be explained further below, generated by the phase-difference instructing unit 24, and a route-delay-time storage unit 35 that stores a delay time for each route of measured partial circuits.

Furthermore, the storage unit 11 includes a phase-difference setting information storage unit 36 that stores phase-difference setting information when set by the phase-difference setting unit 23.

Still further, the storage unit 11 includes a signal-waveform storage unit 37 that stores the simulation signal waveform generated by the signal-waveform generating unit 25 and a simulation-result storage unit 38 that stores the timing analysis result of the analysis-target circuit obtained by the simulation performing unit 26.

Still further, the storage unit 11 includes a delay-characteristic-library storage unit 39 that stores the delay characteristic library generated by the delay-characteristic-library generating unit 27.

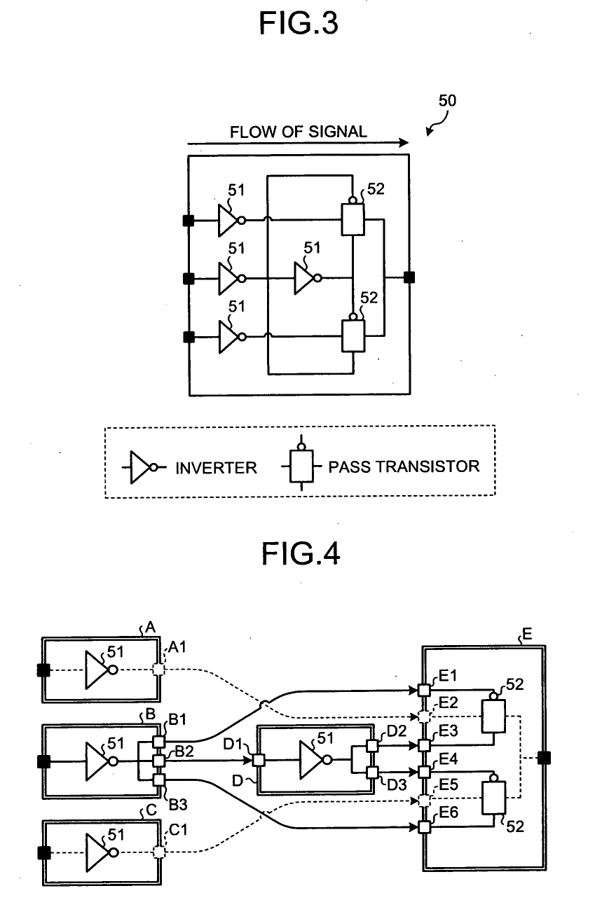

FIG. 3 is a drawing for briefly explaining a part of a logic circuit. FIG. 4 is a drawing for briefly explaining a partial circuit obtained through block division of a part of the logic circuit.

A logic circuit 50 depicted in FIG. 3 is formed of inverters 51 and pass transistors 52. Here, although details of each of the inverters 51 in the logic circuit 50 are not depicted, each inverter is formed of one or more transistors, for example.

The block dividing unit 21 divides a part of the logic circuit 50 depicted in FIG. 3 into a plurality of partial circuits as depicted in FIG. 4 in units of blocks with reference to gate terminals of the transistors and source terminals of the pass transistors.

Among five partial circuits A, B, C, D, and E depicted in FIG. 4, consider here the partial circuit E. The partial circuit E is formed of the two pass transistors 52, with a signal input to an input terminal E1 of the partial circuit E being from an output terminal B1 of the partial circuit B, with a signal input to an input terminal E2 of the partial circuit E being from an output terminal A1 of the partial circuit A, and with a signal input to an input terminal E3 of the partial circuit E being from an output terminal D2 of the partial circuit D.

Also, an signal input to an input terminal E4 of the partial circuit E is input from an output terminal D3 of the partial circuit D, an signal input to an input terminal E5 of the partial circuit E is input from an output terminal C1 of the partial circuit C, and a signal input to an input terminal E6 of the partial circuit E is input from an output terminal B3 of the partial circuit B.

Here, the signal input to the input terminal E3 of the partial circuit E is considered, for example. The signal input to the input terminal E3 is a signal from an output terminal B2 of the partial circuit B via the partial circuit D.

In other words, a signal output from the partial circuit B is input to the input terminals E1 and E6 of the partial circuit E through the output terminals B1 and B3, and is also reversely inverted via the partial circuit D through the output terminal B2 and then the inverted signal is input to the input terminals E3 and E4 of the partial circuit E.

Here, signals output from the partial circuit B reversely inverted in or passing through a different route to the input terminals E1 and E3 of the pass transistor 52 of the partial circuit E and causing a difference in input timing are referred to as simultaneously-changing signals.

That is, the pass transistor 52 in the partial circuit E, a delay occurs in the signal input to the input terminal E3 compared with the signal input to the input terminal E1 by the passing of the partial circuit D. When simultaneously-changing signals are input to the input terminals E1 and E3, a difference in input timing occurs, causing a phase difference between the simultaneously-changing signals.

To get around this problem, phase-difference setting information is set for each input terminal of the partial circuit (analysis-target circuit) so as to reflect the phase difference occurring at the time of inputting simultaneously-changing signals to the input terminals E1 and E3 of the partial circuit E in the simulation of the timing analysis.

Also, the phase-difference setting unit 23 includes a first phase-difference setting process based on the phase-difference instruction information in the phase-difference instruction storage unit 33, a second phase-difference setting process based on the route-configuration-purpose phase-difference instruction information in the route-configuration-purpose phase-difference instruction storage unit 34, and a third phase-difference setting process based on a route delay time in the route-delay-time storage unit 35.

Also, the phase-difference instructing unit 24 generates phase-difference instruction information, which serves as a base for the phase-difference setting information.

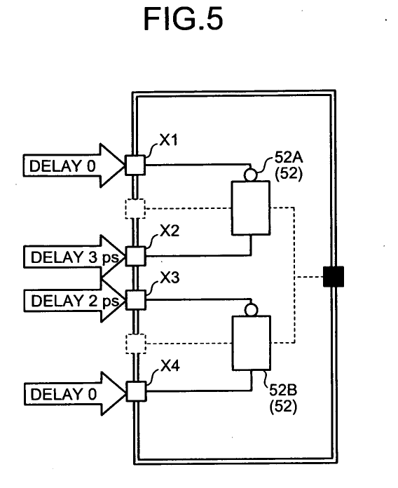

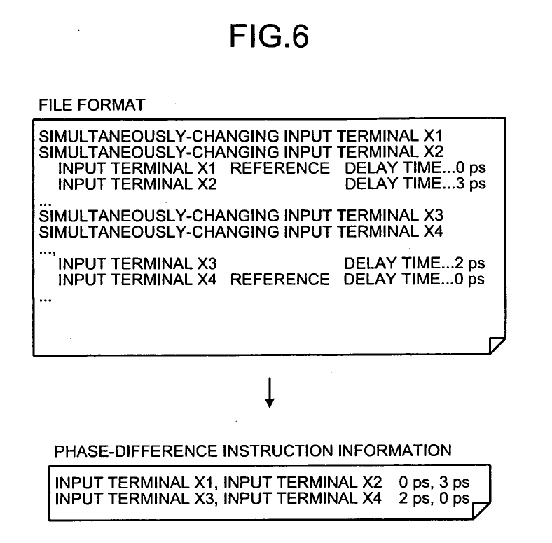

Next, a method of generating phase-difference instruction information in the phase-difference instruction storage unit 33 for use in the first phase-difference setting process together with the first phase-difference setting process is explained. FIG. 5 is a drawing for briefly explaining a concept of the phase-difference instruction information for use in the first phase-difference setting process. FIG. 6 is a drawing for briefly explaining details of phase-difference instruction information stored in the phase-difference instruction storage unit 33.

In the phase-difference instruction information for use in the first phase-difference setting process, a delay time (phase difference) is set as the user arbitrarily chooses for each combination of input terminals of the pass transistor 52, for example.

First, the phase-difference instructing unit 24 specifies, in a file format as depicted in FIG. 6, input terminals where simultaneously-changing signals occur according to the user's operation and specifies, among these specified input terminals, an input terminal serving as a reference. Here, the input terminal serving as a reference also serves as a reference of the delay time, and therefore its delay time is 0.

Upon specifying an input terminal serving as a reference in a file format as depicted in FIG. 6, with reference to the simultaneously-changing signals input to this input terminal serving as a reference, the phase-difference instructing unit 24 arbitrarily specifies a delay time of a simultaneously-changing signal input to another input terminal.

For example, when an input terminal X1 of a pass transistor 52A is taken as a reference, a delay time of a simultaneously-changing signal input to the input terminal X1 is specified as 0 ps, whilst a delay time of a simultaneously-changing signal input to an input terminal X2 is specified as 3 ps. Also, when an input terminal X4 of a pass transistor 52B is taken as a reference, a delay time of a simultaneously-changing signal input to the input terminal X4 is specified as 0 ps, whilst a delay time of a simultaneously-changing signal input to an input terminal X3 is specified as 2 ps.

As a result, upon specification in a file format as depicted in FIG. 6, the phase-difference instructing unit 24 stores “input terminal X1, input terminal X2, 0 ps, 3 ps”, “input terminal X3, input terminal X4, 2 ps, 0 ps” as phase-difference instruction information in the phase-difference instruction storage unit 33.

Therefore, for each combination of input terminals of the pass transistor 52, for example, a delay time can be specified as the user arbitrarily chooses.

When the first phase-difference setting process is performed and a partial circuit for analysis is specified as the analysis-target circuit from among the partial circuits, the phase-difference setting unit 23 determines based on the simulation-purpose pattern for the analysis-target circuit whether a combination of input terminals corresponding to the combination of the input terminals of the analysis-target circuit is included in the phase-difference instruction information in the phase-difference instruction storage unit 33.

When the corresponding combination of the input terminals is included, the phase-difference setting unit 23 sets the phase-difference instruction information corresponding to the combination of the input terminals stored in the phase-difference instruction storage unit 33 as phase-difference setting information for each input terminal of the analysis-target circuit.

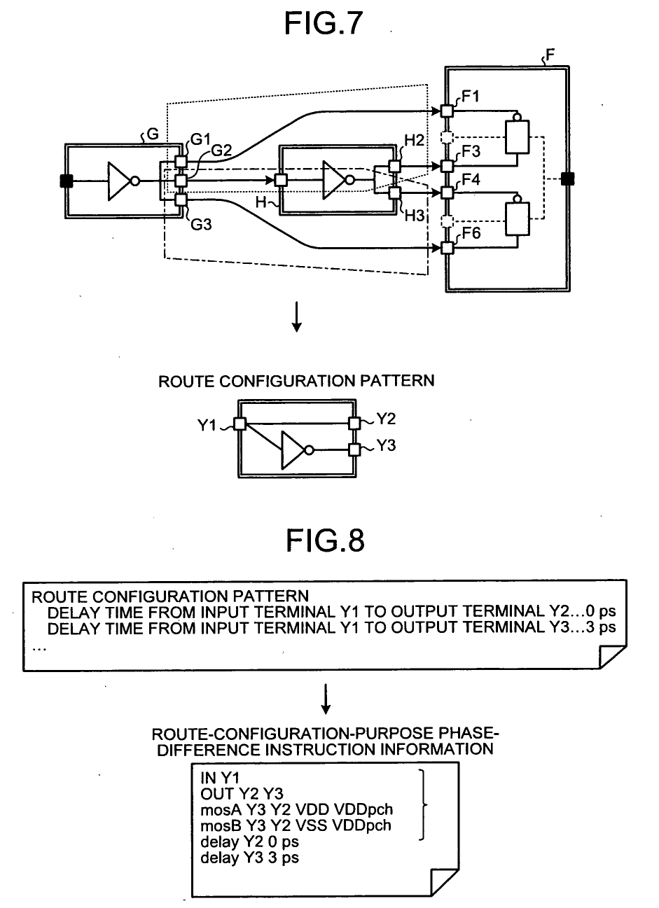

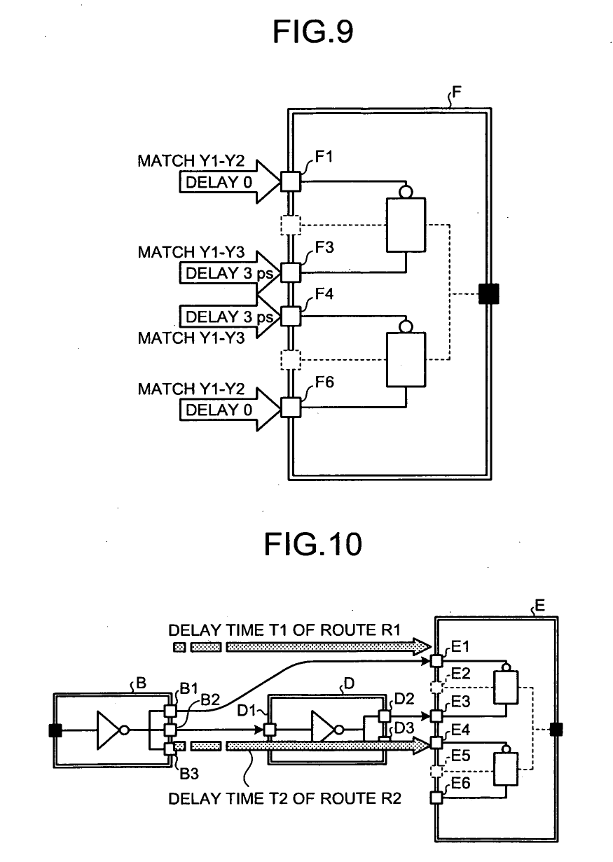

Next, a method of generating route-configuration-purpose phase-difference instruction information in the route-configuration-purpose phase-difference instruction storage unit 34 for use in the second phase-difference setting process together with the second phase-difference setting process is explained. FIG. 7 is a drawing for briefly explaining a concept of the route-configuration-purpose phase-difference instruction information for use in the second phase-difference setting process. FIG. 8 is a drawing for briefly explaining details of route-configuration-purpose phase-difference instruction information stored in the route-configuration-purpose phase-difference instruction storage unit 34. FIG. 9 is a drawing for briefly explaining details of settings to an analysis-target circuit when the second phase-difference setting process is performed.

In the route-configuration-purpose phase-difference instruction information for use in the second phase-difference setting process, a delay time for the input terminal of the partial circuit via the route configuration is set in advance for each route configuration at a stage preceding to the partial circuit.

Consider a route configuration at a stage preceding to input terminals F1 and F3 of a partial circuit F depicted in FIG. 7. This route configuration is formed of output terminals G1 and G2 of a partial circuit G and an output terminal H2 of a partial circuit H, and this route configuration is identified with a route configuration pattern. Here, this route configuration pattern can be identified by using the SPICE net list.

Also, a route configuration at a stage preceding to input terminals F4 and F6 of the partial circuit F is formed of output terminals G2 and G3 of the partial circuit G and an output terminal H3 of the partial circuit H, and its route configuration pattern is similar in to the route configuration pattern at a stage preceding to the input terminals F1 and F3 of the partial circuit F in the sense of pattern.

The phase-difference instructing unit 24 sets delay times in advance for each route in the route configuration in a file format depicted in FIG. 8, for example, a delay time “0 ps” of a route from Y1 to Y2 and a delay time “3 ps” of a route from Y1 to Y3, and then stores the route-configuration-purpose phase-difference instruction information in the route-configuration-purpose phase-difference instruction storage unit 34 in units of route configuration patterns.

Therefore, in the route-configuration-purpose phase-difference instruction information, a delay time is specified for each input terminal of a partial circuit following each route configuration at a stage preceding to the partial circuit.

When the second phase-difference setting process is performed and a partial circuit for analysis is specified as the analysis-target circuit from among the partial circuits, the phase-difference setting unit 23 determines whether the route configuration pattern of the route configuration corresponding to the route configuration at a stage preceding to the analysis-target circuit is included in the route-configuration-purpose phase-difference instruction storage unit 34.

When the route configuration pattern of the route configuration corresponding to the route configuration at a preceding stage is included, the phase-difference setting unit 23 sets the route-configuration-purpose phase-difference instruction information corresponding to the route identification pattern stored in the route-configuration-purpose phase-difference instruction storage unit 34 as phase-difference setting information for each input terminal of the analysis-target circuit based on the simulation-purpose pattern of the analysis-target circuit.

As a result, when the partial circuit F is taken as an analysis-target circuit, based on the route-configuration-purpose phase-difference instruction information depicted in FIG. 8, the phase-difference setting unit 23 sets a delay time of the input terminal F1 as 0 ps and a delay time of the input terminal F3 as 3 ps, as depicted in FIG. 9.

Since the route configuration at the stage preceding to the input terminals F4 and F6 of the partial circuit F has the same route configuration pattern as that of the route configuration at the stage preceding to the input terminals F1 and F3, the phase-difference setting unit 23 sets a delay time of the input terminal F4 as 3 ps and a delay time of the input terminal F6 as 0 ps, as depicted FIG. 9.

Next, a third phase-difference setting process is explained. FIG. 10 is a drawing for briefly explaining a concept of the third phase-difference setting process.

In the route-delay-time storage unit 35, an already-measured delay time for each route between partial circuits is stored.

When the third phase-difference setting process is performed and a partial circuit for analysis is specified as the analysis-target circuit from among the partial circuits, the phase-difference setting unit 23 reads from the route-delay-time storage unit 35 a delay time for each route connected to each input terminal of the analysis-target circuit based on the simulation-purpose pattern of the analysis-target circuit.

Upon reading a delay time for each route connected to each input terminal of the analysis-target circuit, the phase-difference setting unit 23 calculates a phase difference between simultaneously-changing signals with reference to a delay time of one route from among the delay times of routes different for each input terminal of the analysis-target circuit, and sets the calculated phase difference as phase-difference setting information for each input terminal of the analysis-target circuit.

Here, in FIG. 10, when a partial circuit E for analysis is taken as an analysis-target circuit, the route-delay-time storage unit 35 has stored therein at least a delay time T1 of a route R1 from an output terminal B1 of a partial circuit B to an input terminal E1 of the partial circuit E and a delay time T2 of a route R2 from an output terminal B2 of the partial circuit B to an input terminal E3 of the partial circuit E via a partial circuit D.

When the third phase-difference setting process is performed, the phase-difference setting unit 23 specifies the partial circuit E as an analysis-target circuit and, when the delay time of the fastest route R1 is taken as a reference from among the delay times of the routes different for each input terminal of the analysis-target circuit, (delay time T2 of route R2)−(delay time T1 of route R1) is performed to calculate a phase difference between simultaneously-changing signals of the input terminals E1 and E3.

Upon calculating a phase difference between simultaneously-changing signals of the input terminals E1 and E3, the phase-difference setting unit 23 stores the calculated phase difference as phase-difference setting information in the phase-difference setting information storage unit 36.

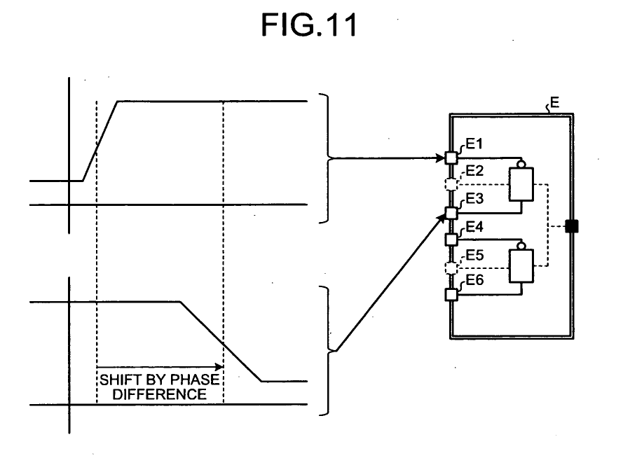

FIG. 11 is a drawing for briefly explaining a simulation-purpose signal waveform being shifted by the phase difference based on the phase-difference setting information.

When the phase-difference setting information of the target-analysis circuit is set by the phase-difference setting unit 23, the signal-waveform generating unit 25 selects a simulation signal waveform input to each input terminal of the analysis-target circuit from the net-list storage unit 31 based on the simulation-purpose pattern of the analysis-target circuit.

Upon selecting a simulation signal waveform input to each input terminal of the analysis-target circuit, the signal-waveform generating unit 25 reflects the phase difference based on the phase-difference setting information to the selected simulation signal waveform to generate a simulation signal waveform being shifted by the phase difference as depicted in FIG. 11, and then stores the generated simulation signal waveform in the signal-waveform storage unit 37.

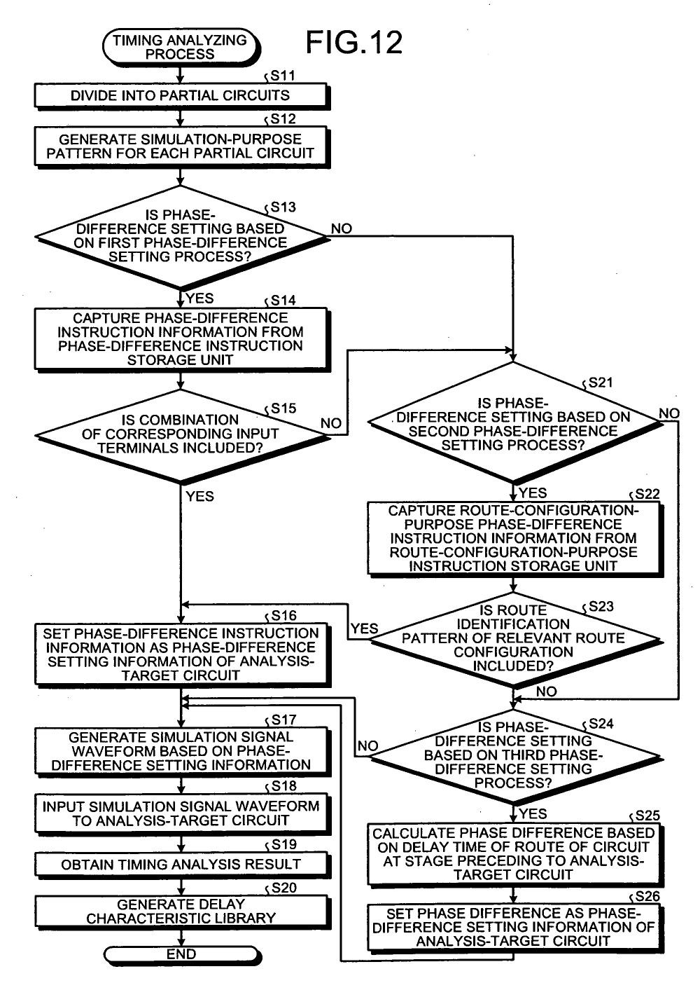

Next, the operation of the circuit simulating apparatus 1 according to the present embodiment is explained. FIG. 12 is a flowchart of a process operation of the controlling unit 16 involved in a timing analyzing process of the timing analyzing apparatus 4.

In FIG. 12, the block dividing unit 21 in the controlling unit 16 divides a partial logic circuit of the whole circuit into a plurality of partial circuits in units of blocks, as depicted in FIGS. 3 and 4, based on the SPICE net list of the whole circuit stored in the net-list storage unit 31 (Step S11).

The pattern generating unit 22 generates a simulation-purpose pattern for an input terminal of each partial circuit for each partial circuit (Step S12). Here, the pattern generating unit 22 stores the simulation-purpose pattern in the simulation-purpose pattern storage unit 32.

When the partial circuit E for analysis is specified as an analysis-target circuit from among the partial circuits, the phase-difference setting unit 23 determines whether the phase-difference setting is based on the first phase-difference setting process (Step S13). Here, whether the phase-difference setting is based on the first phase-difference setting process depends on user's selection setting.

When the phase-difference setting is based on the first phase-difference setting process (Yes at Step S13), the phase-difference setting unit 23 captures phase-difference instruction information stored in the phase-difference instruction storage unit 33 (Step S14), and determines based on the simulation-purpose pattern of the analysis-target circuit whether a combination of input terminals corresponding to a combination of input terminals of the analysis-target circuit is included in the captured phase-difference instruction information (Step S15).

When a combination of input terminals corresponding to a combination of input terminals of the analysis-target circuit is included (Yes at Step S15), the phase-difference setting unit 23 sets the phase-difference instruction information as phase-difference setting information of the analysis-target circuit so as to set to the input terminals of the analysis-target circuit a phase difference in the phase-difference instruction information associated with the combination of the input terminals (Step S16). Here, upon setting the phase-difference instruction information as phase-difference setting information of the analysis-target circuit, the phase-difference setting unit 23 stores the phase-difference setting information in the phase-difference setting information storage unit 36.

Based on the simulation-purpose pattern of the analysis-target circuit, the signal-waveform generating unit 25 selects from the net-list storage unit 31 a simulation signal waveform input to each input terminal of the analysis-target circuit and, based on the phase-difference setting information of the analysis-target circuit stored in the phase-difference setting information storage unit 36, generates a simulation-purpose signal waveform being shifted by the phase difference for each input terminal, as depicted in FIG. 11 (Step S17). Here, the signal-waveform generating unit 25 stores the simulation signal waveform generated for each input terminal in the signal-waveform storage unit 37.

The simulation performing unit 26 inputs the simulation signal waveform reflecting the phase difference stored in the signal-waveform storage unit 37 for each input terminal of the analysis-target circuit (Step S18).

Upon inputting the simulation signal waveform reflecting the phase difference for each input terminal of the analysis-target circuit, the simulation performing unit 26 obtains a timing analysis result of the analysis-target circuit based on the input result (Step S19). Here, upon obtaining the timing analysis result of the analysis-target circuit, the simulation performing unit 26 stores the obtained timing analysis result in the simulation-result storage unit 38.

The delay-characteristic-library generating unit 27 then sequentially generates a delay characteristic library for the whole circuit from the timing analysis result of the analysis-target circuit stored in the simulation-result storage unit 38 and the timing analysis result of the measured analysis-target circuit (Step S20), and then ends the process operation depicted in FIG. 12. Here, the delay-characteristic-library generating unit 27 sequentially stores the sequentially-generated delay characteristic library in the delay-characteristic-library storage unit 39.

When the phase-difference setting is not based on the first phase-difference setting process (No at Step S13), the phase-difference setting unit 23 determines whether the phase-difference setting is based on the second phase-difference setting process (Step S21). Here, whether the phase-difference setting is based on the second phase-difference setting process depends on user's selection setting.

When the phase-difference setting is based on the second phase-difference setting process (Yes at Step S21), the phase-difference setting unit 23 captures route-configuration-purpose phase-difference instruction information from the route-configuration-purpose phase-difference instruction storage unit 34 (Step S22) to determine whether a route identification pattern of a route configuration relevant to the route configuration at a stage preceding to the analysis-target circuit is included in the captured route-configuration-purpose phase-difference instruction information (Step S23).

When a route identification pattern of a route configuration relevant to the route configuration at a stage preceding to the analysis-target circuit is included (“Yes” at Step S23), the phase-difference setting unit 23 proceeds to Step S16 so as to set the route-configuration-purpose phase-difference instruction information corresponding to the route configuration pattern as phase-difference setting information.

When the phase-difference setting is not based on the second phase-difference setting process (No at Step S21), the phase-difference setting unit 23 determines whether the phase-difference setting is based on the third phase-difference setting process (Step S24). Here, whether the phase-difference setting is based on the third phase-difference setting process depends on user's selection setting.

When the phase-difference setting is based on the third phase-difference setting process (Yes at Step S24), the phase-difference setting unit 23 calculates a phase difference based on the delay time of each route of a circuit at a stage preceding to the analysis-target circuit stored in the route-delay-time storage unit 35 (Step S25), sets the calculated phase difference as phase-difference setting information for each input terminal of the analysis-target circuit (Step S26), and then goes to Step S17 so as to generate a simulation signal waveform of the analysis-target circuit. Here, upon setting the phase-difference setting information of the analysis-target circuit at Step S26, the phase-difference setting unit 23 stores the phase-difference setting information in the phase-difference setting information storage unit 36.

Also, when the phase-difference setting is not based on the third phase-difference setting process (No at Step S24), the phase-difference setting unit 23 does not perform phase-difference setting of the analysis-target circuit, and then the procedure goes to Step S17 so as to generate a simulation-purpose signal waveform.

In the timing-analysis simulation process depicted in FIG. 12, when the first phase-difference setting process is performed by specifying a partial circuit for analysis as an analysis-target circuit, when it is determined based on the simulation-purpose pattern of the analysis-target circuit that phase-difference instruction information corresponding to a combination of input terminals relevant to a combination of input terminals of the analysis-target circuit is included, the phase-difference instruction information is set as phase-difference setting information for each input terminal of the analysis-target circuit. As a result, based on this phase-difference setting information, a simulation signal waveform reflecting the phase difference is input to the analysis-target circuit, thereby achieving timing analysis with high accuracy. Also, in the first phase-difference setting process, phase differences of simulation signal waveforms of simultaneously-changing signals with respect to the analysis-target circuit can be individually set. Therefore, for example, an analysis with a phase difference arbitrarily set by a user can be performed, for example, at the time of design change or estimation of a not-yet-designed portion.

Also, in the timing-analysis simulation process, when the second phase-difference setting process is performed by specifying a partial circuit for analysis as an analysis-target circuit and a route configuration pattern of the route configuration corresponding to the route configuration at a stage preceding to the analysis-target circuit is included in the route-configuration-purpose phase-difference instruction storage unit 34, the route-configuration-purpose phase-difference instruction information corresponding to the route identification pattern is set as phase-difference setting information for each input terminal of the analysis-target circuit based on the simulation-purpose pattern of the analysis-target circuit. As a result, based on the phase-difference setting information, a simulation signal waveform reflecting the phase difference is input to the analysis-target circuit, thereby achieving timing analysis with high accuracy. In the second phase-difference setting process, by setting an appropriate phase difference to the route configuration to which simultaneously-changing signals are input, operation load by manual setting can be significantly reduced.

Furthermore, in the timing-analysis simulation process, when the third phase-difference setting process is performed by specifying a partial circuit for analysis as an analysis-target circuit, a phase difference between signals with reference to a delay signal of one route from among delay times of route different for each input terminal of the analysis-target circuit stored in the route-delay-time storage unit 35 is calculated, and the calculated phase difference is set as phase-difference setting information for each input terminal of the analysis-target circuit. As a result, based on the phase-difference setting information, a simulation signal waveform reflecting the phase difference to the analysis-target circuit is input, thereby achieving timing analysis with high accuracy. In the third phase-difference setting process, by setting the phase difference by automatically calculating the delay time of the route to which simultaneously-changing signals are input, operation load by manual setting can be significantly reduced.

According to the present embodiment, when a partial circuit for analysis is specified as an analysis-target circuit, for each input terminal of the analysis-target circuit, a phase difference between input simultaneously-changing signals each obtained from one signal passing through or inverted in a different route is set as phase-difference setting information and, based on the phase-difference setting information of the analysis-target circuit, for each input terminal of the analysis-target circuit, a simulation signal waveform reflecting the phase difference is generated for input. As a result, in the present embodiment, a simulation reflecting the phase difference between simultaneously-changing signals input to the analysis-target circuit is achieved, thereby achieving timing analysis with high accuracy.

In general, the delay time is at maximum when timings of turning each channel of the pass transistors ON are the same. In the present embodiment, the delay time can be reduced by providing the phase difference to the timing of turning each channel ON. Therefore, an excessive estimation of the delay time at the time of designing can be avoided, and a time required for compiling design timings of the LSI circuit due to such an excessive estimation of the delay time can be reduced.

Furthermore, in the embodiment, as depicted in the timing analyzing process of FIG. 12, phase-difference setting is performed in the setting order of the first phase-difference setting process→the second phase-difference setting process→the third phase-difference setting process in an alternative manner. Here, the setting order can be changed as appropriate.

Still further, in the embodiment, phase-difference setting is performed in the setting order of the first phase-difference setting process→the second phase-difference setting process→the third phase-difference setting process. Alternatively, any one of these first, second, and third phase-difference setting processes can be selected as appropriate for phase-difference setting through user selection.

In the foregoing, while the embodiment of the present invention has been explained, the range of the technical idea of the present invention is not meant to be restricted by the embodiment, and various embodiments can be implemented as long as they do not deviate from the range of the technical idea recited in the claims. Also, the effects recited in the embodiment are not meant to be restrictive.

Furthermore, among the various processes explained in the embodiment, all or part of the processes explained as being automatically performed can be manually performed or, conversely, all or part of the processes explained as being manually performed can be automatically performed. In addition, the process procedure, the control procedure, specific names, and information including various data and parameters explained in the embodiment can be arbitrarily changed unless otherwise specified.

Still further, each component depicted is conceptual in function, and is not necessarily physically configured as depicted. The specific patterns of the components are not meant to be restricted to those depicted in the drawings.

Still further, all or arbitrary part of various process functions performed in each component can be achieved by a Central Processing Unit (CPU) (or a microcomputer, such as Micro Processing Unit (MPU) or Micro Controller Unit (MCU)) and a program analyzed and executed on that CPU (or microcomputer, such as MPU or MCU), or can be achieved as hardware with a wired logic.

According to the embodiments, timing analysis can be achieved with high accuracy.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A computer readable storage medium containing instructions concerning a circuit simulation that, when executed by a computer, cause the computer to perform:
dividing a logic circuit including a plurality of circuits into a plurality of partial circuits in units of blocks;
generating, for each of the partial circuits, a simulation-purpose pattern including information input to an input terminal of the partial circuit;
setting, when a partial circuit for analysis is specified as an analysis-target circuit from among the partial circuits, a phase difference between input simultaneously-changing signals as phase-difference setting information for each input terminal of the analysis-target circuit based on the simulation-purpose pattern corresponding to the analysis-target circuit, the simultaneously-changing signals each being obtained from one signal from a preceding circuit passing through or inverted in a different route;
generating a simulation signal waveform reflecting the phase difference for each input terminal of the analysis-target circuit based on the simulation-purpose pattern of the analysis-target circuit and the phase-difference setting information of the analysis-target circuit; and
receiving an input of the simulation signal waveform for each input terminal of the analysis-target circuit, the simulation signal waveform being generated by the signal-waveform generating unit, to obtain a timing analysis result of the analysis-target circuit based on the input result.

2. The computer readable storage medium according to claim 1, wherein the instructions further cause the computer to perform:
receiving, for each input terminal of the partial circuit, an input of an arbitrary phase difference between the input simultaneously-changing signals according to a predetermined operation; and
storing the arbitrary phase difference as phase-difference instruction information for each combination of the input terminals to which the simultaneously-changing signals are input, wherein
the setting includes, when a partial circuit for analysis is specified as an analysis-target and it is determined based on the simulation-purpose pattern of the analysis-target circuit that a combination of input terminals relevant to a combination of input terminals of the analysis-target circuit is stored in the storing the arbitrary phase difference, setting, as the phase-difference setting information for each input terminal of the analysis-target circuit, the phase-difference instruction information corresponding to the combination of the input terminals stored in the storing the arbitrary phase difference.

3. The computer readable storage medium according to claim 1, wherein the instructions further cause the computer to perform
storing, for each route identification pattern identifying a route configuration, route-configuration-purpose phase-difference instruction information set with a phase difference between signals output from an input of the route configuration, wherein
the setting includes, when a partial circuit for analysis is specified as an analysis-target circuit and when a route identification pattern of a route configuration relevant to a route configuration at a stage preceding to the analysis-target circuit is stored in the storing the route-configuration-purpose phase-difference instruction information, setting, as the phase-difference setting information for each input terminal of the analysis-target circuit, the route-configuration-purpose phase-difference instruction information corresponding to the route identification pattern stored in the storing the route-configuration-purpose phase-difference instruction information, based on the simulation-purpose pattern of the analysis-target circuit.

4. The computer readable storage medium according to claim 1, wherein the instructions further cause the computer to perform storing a delay time for each of the routes associated with the partial circuits, wherein
the setting includes, when a partial circuit for analysis is specified as an analysis-target circuit, based on the simulation-purpose pattern of the analysis-target circuit, reading a delay time stored in the storing the delay time for each route connected to each input terminal of the analysis-target circuit, calculating a phase difference between signals with reference to a delay time of one route among delay times of routes different for each input terminal of the analysis-target circuit, and setting the calculated phase difference as the phase-difference setting information for each input terminal of the analysis-target circuit.

5. A circuit simulating apparatus comprising:
a block dividing unit that divides a logic circuit including a plurality of circuits into a plurality of partial circuits in units of blocks;
a pattern generating unit that generates, for each of the partial circuits, a simulation-purpose pattern including information input to an input terminal of the partial circuit;
a phase-difference setting unit that sets, when a partial circuit for analysis is specified as an analysis-target circuit from among the partial circuits, a phase difference between input simultaneously-changing signals as phase-difference setting information for each input terminal of the analysis-target circuit based on the simulation-purpose pattern corresponding to the analysis-target circuit, the simultaneously-changing signals each being obtained from one signal from a preceding circuit passing through or inverted in a different route;
a signal-waveform generating unit that generates a simulation signal waveform reflecting the phase difference for each input terminal of the analysis-target circuit based on the simulation-purpose pattern of the analysis-target circuit and the phase-difference setting information of the analysis-target circuit; and
a simulation performing unit that receives an input of the simulation signal waveform for each input terminal of the analysis-target circuit, the simulation signal waveform being generated by the signal-waveform generating unit, to obtain a timing analysis result of the analysis-target circuit based on the input result.

6. The circuit simulating apparatus according to claim 5, further comprising a phase-difference instruction storage unit that receives, for each input terminal of the partial circuit, an input of an arbitrary phase difference between the input simultaneously-changing signals according to a predetermined operation and stores the arbitrary phase difference as phase-difference instruction information for each combination of the input terminals to which the simultaneously-changing signals are input, wherein
when a partial circuit for analysis is specified as an analysis-target and it is determined based on the simulation-purpose pattern of the analysis-target circuit that a combination of input terminals relevant to a combination of input terminals of the analysis-target circuit is included in the phase-difference instruction storage unit, the phase-difference setting units sets, as the phase-difference setting information for each input terminal of the analysis-target circuit, the phase-difference instruction information corresponding to the combination of the input terminals stored in the phase-difference instruction storage unit.

7. The circuit simulating apparatus according to claim 5, further comprising a route-configuration-purpose phase-difference storage unit that stores, for each route identification pattern identifying a route configuration, route-configuration-purpose phase-difference instruction information set with a phase difference between signals output from an input of the route configuration, wherein
when a partial circuit for analysis is specified as an analysis-target circuit and when a route identification pattern of a route configuration relevant to a route configuration at a stage preceding to the analysis-target circuit is included in the route-configuration-purpose phase-difference storage unit, based on the simulation-purpose pattern of the analysis-target circuit, the phase-difference setting unit sets route-configuration-purpose phase-difference instruction information corresponding to the route identification pattern stored in the route-configuration-purpose phase-difference storage unit as the phase-difference setting information for each input terminal of the analysis-target circuit.

8. The circuit simulating apparatus according to claim 5, further comprising a delay-time storage unit that stores a delay time for each of the routes associated with the partial circuits, wherein
when a partial circuit for analysis is specified as an analysis-target circuit, based on the simulation-purpose pattern of the analysis-target circuit, the phase-difference setting unit reads from the delay-time storage unit a delay time for each route connected to each input terminal of the analysis-target circuit, calculates a phase difference between signals with reference to a delay time of one route among delay times of routes different for each input terminal of the analysis-target circuit, and sets the calculated phase difference as the phase-difference setting information for each input terminal of the analysis-target circuit.

9. A circuit simulating method comprising:
dividing a logic circuit including a plurality of circuits into a plurality of partial circuits in units of blocks;
generating, for each of the partial circuits, a simulation-purpose pattern including information input to an input terminal of the partial circuit;
setting, when a partial circuit for analysis is specified as an analysis-target circuit from among the partial circuits, a phase difference between input simultaneously-changing signals as phase-difference setting information for each input terminal of the analysis-target circuit based on the simulation-purpose pattern corresponding to the analysis-target circuit, the simultaneously-changing signals each being obtained from one signal from a preceding circuit passing through or inverted in a different route;
generating a simulation signal waveform reflecting the phase difference for each input terminal of the analysis-target circuit based on the simulation-purpose pattern of the analysis-target circuit and the phase-difference setting information of the analysis-target circuit; and
receiving an input of the simulation signal waveform for each input terminal of the analysis-target circuit, the simulation signal waveform being generated by the signal-waveform generating unit, to obtain a timing analysis result of the analysis-target circuit based on the input result.

10. The method according to claim 9, further comprising:
receiving, for each input terminal of the partial circuit, an input of an arbitrary phase difference between the input simultaneously-changing signals according to a predetermined operation; and
storing the arbitrary phase difference as phase-difference instruction information for each combination of the input terminals to which the simultaneously-changing signals are input, wherein
the setting includes, when a partial circuit for analysis is specified as an analysis-target and it is determined based on the simulation-purpose pattern of the analysis-target circuit that a combination of input terminals relevant to a combination of input terminals of the analysis-target circuit is stored in the storing the arbitrary phase difference, setting, as the phase-difference setting information for each input terminal of the analysis-target circuit, the phase-difference instruction information corresponding to the combination of the input terminals stored in the storing the arbitrary phase difference.

11. The method according to claim 9, further comprising storing, for each route identification pattern identifying a route configuration, route-configuration-purpose phase-difference instruction information set with a phase difference between signals output from an input of the route configuration, wherein
the setting includes, when a partial circuit for analysis is specified as an analysis-target circuit and when a route identification pattern of a route configuration relevant to a route configuration at a stage preceding to the analysis-target circuit is stored in the storing, the route-configuration-purpose phase-difference instruction information, setting, as the phase-difference setting information for each input terminal of the analysis-target circuit, the route-configuration-purpose phase-difference instruction information corresponding to the route identification pattern stored in the storing the route-configuration-purpose phase-difference instruction information, based on the simulation-purpose pattern of the analysis-target circuit.

12. The method according to claim 9, further comprising storing a delay time for each of the routes associated with the partial circuits, wherein
the setting includes, when a partial circuit for analysis is specified as an analysis-target circuit, based on the simulation-purpose pattern of the analysis-target circuit, reading a delay time stored in the storing the delay time for each route connected to each input terminal of the analysis-target circuit, calculating a phase difference between signals with reference to a delay time of one route among delay times of routes different for each input terminal of the analysis-target circuit, and setting the calculated phase difference as the phase-difference setting information for each input terminal of the analysis-target circuit.
